(19) United States
(12) Patent Application Publication
(10) Pub. No.: US 2025/0375772 A1
(43) Pub. Date: Dec. 11, 2025

(54) LABORATORY MILL

(71) Applicant: FRITSCH GMBH, Idar-Oberstein (DE)

(72) Inventors: Marco Bauer, Merxheim (DE); Markus Bund, Marpingen (DE); Eugen Kompanez, Baumholder (DE); Juri Dinges, Idar-Oberstein (DE)

(21) Appl. No.: 18/876,987

(22) PCT Filed: Jun. 13, 2023
(86) PCT No.: PCT/EP2023/065765

§ 371 Date: Dec. 19, 2024

(30) Foreign Application Priority Data
Jun. 20, 2022 (DE) 10 2022 115 335.5

(51) Int. Cl. B02C 18/14; B02C 18/18

(52) U.S. Cl. CPC B02C 18/144; B02C 18/18

(57) ABSTRACT

The invention relates to a laboratory mill (1) for comminuting grist, in particular configured as a cutting mill or cross beater mill, comprising
a device housing (12) having a grinder housing (16), wherein the grinder housing (16) defines a grinding chamber (32) and has an axial end face (16a),
a rotor-grinder in the grinding chamber (32) of the grinder housing (16), wherein the rotor-grinder (30) comprises a rotor (34), which defines a rotor axis (X), and at least one counter-element (36), wherein the grist is comminuted between the rotor (34) and the at least one counter-element (36) when the rotor (34) rotates,
a grinder drive (2, 4) for driving the rotor (34) in the grinding chamber (32),
a grinder housing door (18) for closing the grinder housing (16) at the axial end face (16a)
wherein the at least one counter-element can be inserted axially into the grinder housing (36) when the grinder housing door (18) is open.

### TECHNICAL FIELD

The present disclosure relates to a laboratory mill, in particular a cutting mill or a cross beater mill on a laboratory scale, which comprise a grinder in which grist is comminuted e.g. in a grinding gap between a grinder rotor and one or more stationary counter-elements, by a cutting and/or beating action.

### BACKGROUND

Cutting mills comminute grist between a rotating cutting rotor having one or more rotor blades that extend substantially axially and one or more stationary counter-blades that also extend substantially axially according to the scissor principle in the grinding gap extending axially therebetween. Such laboratory cutting mills are in particular suitable for comminuting tough or fibrous samples, e.g. biological samples such as straw but e.g. also plastics films, to name just some examples. Examples for current laboratory cutting mills are e.g. the PULVERISETTER 19 and the PULVERISETTER 15 by the applicant, to the basic construction of which reference is hereby made. Corresponding product descriptions of the PULVERISETTER 19 and the PULVERISETTER 15 can be found e.g. at www.fritsch.de.

In the case of these cutting mills on a laboratory scale, typically more or less trickable or pourable bulk material is filled into the grinding chamber e.g. via a filling funnel, in which chamber the cutting rotor rotates about a horizontal axis. The cutting rotor can have different geometries, e.g. with straight blades or what are known as V-blades. The latter exhibit twist and thereby achieve a good cutting action, above all in the case of comminution of tough-elastic materials and films.

Typically a sieve, e.g. a sieve cassette, is located below the cutting rotor, through which sieve the sample material, which has already been sufficiently comminuted, can trickle in order to be collected in a collecting vessel located therebelow. With regard to further structural details of a cutting mill, which are essentially known to a person skilled in the art in this field, reference is made to the product descriptions relating to the cutting mills PULVERISETTER 19 and PULVERISETTER 15 by the applicant, which, at the time of the application and the publication thereof, can be downloaded at www.fritsch.de, and which are hereby incorporated by reference with respect to the fundamental construction of a cutting mill of this kind. Furthermore, the applications DE 196 01 594, DE 10 2018 113 751 A1, WO 2020/200759 A1 and DE 10 2019 133 437 A1 describe such cutting mills and are hereby also incorporated by reference.

The cutting blades are subject to wear, as a result of which the cutting gap may change, in an undesired manner, over time. Furthermore, the cutting blades can be damaged by hard grist, which may require resharpening, as a result of which the width of the cutting gap also changes. Therefore, the grinding gaps in such mills can typically be set by the user, and the user can subsequently adjust the blades in order to set the width of the cutting gap between the blades of the rotor and the counter-blades to a desired amount and the desired parallelism. With reference to FIG. 23, in a conventional cutting mill 100 typically the radial positioning of the stationary counter-blades 102 is set by means of two setscrews 104. Then, the counter-blades 102 are pulled against these stops by means of a further screw 106, in order to fix said blades. The blades of the rotor are typically fix by shape and sharpening, or if individual blades are used on the rotor these are mounted on the rotor and then subsequently the blades of the stationary counter-blades 102 are set and fixed relative to the rotor blades. This setting of the cutting gap has proven itself in principle, but also has some disadvantages.

Firstly, this setting is not particularly easy and requires experience, which may mean that it cannot always be managed optimally by the user. Furthermore, the grinding gaps change not only due to wear, but rather can also be misaligned after dismantling and remounting. In particular in the case of an undivided grinder housing, the cutting gap can be reached and measured only with difficulty at a rear motor-side end.

A further disadvantage is that the user may also set the cutting or grinding gap to be too small. This then results either in a too small grinding gap, which may lead to increased blade wear, excessive heating, and high machine stress, or, which is more disadvantageous, overlapping of the blades. The latter may lead to damage upon startup of the mill, and is not a particularly rare occurrence.

A further disadvantage is that the adjusting screws, threads, locking nuts, etc., which are used for the setting, are additional components and thwart a hygienic design of the grinder.

In addition, this type of adjustment may limit the size of the mill downwards, since, in the case of smaller mills the individual elements would also have to shrink, which would make the adjustment even more difficult.

Thus, overall, some things may be done “incorrectly” during adjustment.

Similar disadvantages also apply for cross beater mills (cf. PULVERISETTER 16, www.fritsch.de), the product descriptions of which are hereby also incorporated by reference. A cross beater mill comprises a similar grinder to a cutting mill, wherein, however, there is typically a greater width of the grinding gap than in the case of a cutting mill. As a result, the comminution effect can be based increasingly on a beating effect.

The present disclosure describes and illustrates a laboratory mill, in particular a cutting mill or cross beater mill, which is simple to use and requires little specialist knowledge and operating outlay by the user.

A further aspect of the present disclosure is that of providing a laboratory mill, in particular a cutting mill or cross beater mill, which is cost-effective and has a low susceptibility to faults, and also requires little maintenance outlay.

A further aspect of the present disclosure is that of providing a laboratory mill, in particular a cutting mill or cross beater mill, which is easy to clean and in which the width of the grinding gap can be changed by the user very easily and in a failsafe manner.

A further aspect of the present disclosure is that of providing a laboratory mill, in particular a cutting mill or cross beater mill, which can be made particularly small and compact.

The object of the present disclosure is achieved by the subject matter of the independent claims. Additional developments of the present disclosure are defined in the dependent claims.

According to the present disclosure, a laboratory mill for comminuting grist is provided, which comprises a device housing and a grinder housing in which the rotor-grinder is located. The grinder housing can in particular consist of solid metal, e.g. of aluminum or stainless steel. The grinder housing defines an, in particular substantially cylindrical, grinding chamber in which the rotor-grinder, consisting of the rotor and at least one stationary counter-element, is inserted. The rotor or its drive defines, with its axis of rotation, the central axis of the grinding chamber or of the grinder housing. The grinder housing can have a rear, drive-side axial end face by means of which the grinder housing can be flanged to a rear part of the device housing. The grinder housing in particular has a front axial end face that is opposite the grinder drive and from which the user has axial access to the grinder.

The rotor-grinder is thus inserted into the grinding chamber of the grinder housing, wherein the rotor can be plugged or pushed onto a drive shaft. The at least one stationary counter-element is inserted into the grinder housing in parallel with the rotor, in order to form a defined grinding gap between the rotor and the at least one counter-element, in which gap the grist is comminuted when the rotor rotates relative to the at least one counter-element. Optionally, the grinder comprises a rotor having a plurality of, e.g. two, three, four or more, cutting blades or beater bars, and the laboratory mill comprises a plurality of, e.g. two, three, four or more counter-elements, which are arranged around the rotor, along the rotor periphery. In the present application, “at least one” thus means one or more, in particular two, three, four or more, such components.

The laboratory mill is in particular configured as a cutting mill or cross beater mill on a laboratory scale. Thus, the rotor can be configured as a cutting rotor and the at least one counter-element as a stationary counter-blade of a cutting mill, or the rotor can be configured as a beater rotor and the at least one counter-element as a stationary counter-beater bar of a cross beater mill.

The grinder drive is preferably accommodated in the device housing and drives the rotor via a drive shaft which extends axially into the grinding chamber. The rotor and/or the counter-element(s) extend axially into the grinding chamber, preferably from a rear motor-side end to a front end of the grinding chamber opposite the drive, in particular as far as the grinder housing door. The drive shaft can enter the grinding chamber e.g. through a shaft through-opening on the motor-side end of the grinding chamber.

The grinder housing or the grinding chamber are open at a front end, i.e. the end opposite the motor-side end, as a result of which an axial user access opening is provided, via which the user can insert and remove the rotor, the counter-element(s), and optionally further exchangeable grinder components, e.g. in order to be able to clean, maintain or exchange these, and also in order to clean the grinding chamber.

For operation of the laboratory mill, the user access opening is closed by a grinder housing door, which is suspended on the grinder housing e.g. pivotably by means of hinges. The grinder housing door has an open and a closed state, wherein the user has access to the grinder in the open state and the laboratory mill can be operated safely when the grinder housing door is closed. The laboratory mill can also comprise a smaller axial or radial filling opening for grist, e.g. having a filling funnel, through which grist can be supplied continuously during operation. The grinder housing door can comprise a door closure, by means of which it can be locked in the closed state, and safety devices which ensure the locking of the grinder housing door during operation. Reference is made to the parallel patent application, filed by the same applicant on the same day, having the title “Laboratory mill” [“Labormühle”], which is hereby incorporated by reference.

The at least one or the plurality of stationary counter-elements can be plugged or slid axially into the grinder housing, when the grinder housing door is open.

For this purpose, the grinder housing, with the counter-element(s), in each case forms an axially displaceable guide having a radially acting form-fitting connection, e.g. in the form of an axially displaceable tongue-and-groove guide as a linear guide.

The respective radial form-fitting connection forms a support against a movement of the counter-element(s) radially inwards towards the rotor, such that the movement of the respective counter-element radially inwards towards the rotor is limited. The form-fitting support for the associated counter-element against the movement radially inwards towards the rotor is thus formed e.g. by the tongue-and-groove guide.

In this case, the counter-element(s) are preferably plugged only loosely into the grinder housing. The radial end positions of the counter-element(s) are limited in the grinder housing, in particular in a form-fitting manner, in particular against a movement radially inwards, in order to define the smallest dimension of the grinding gap. The counter-element(s) are thus pushed axially into the linear guide with a radial form-fitting connection, and the grinding gap is defined by the radial form-fitting connection of the axially extending linear guide. In particular, the linear guide limits a movement of the counter-element(s) radially inwards. In particular, no further radial and/or axial fastening, e.g. screwing, and/or no adjusting means and/or no radial tensioning, e.g. by screws, etc. is required. In particular, the counter-element(s) are not screwed in operation of the laboratory mill. The counter-elements are in particular not radially adjustable, e.g. by means of setscrews, in order to set the grinding gap (cutting gap or beating gap) between the rotor and the at least one counter-element.

The definition of the width of the grinding gap takes place exclusively by the geometry of the parts and the linear guide, or the radial form-fitting connection of the linear guide. The linear guide is in particular a single-axis linear guide. The width of the grinding gap thus is not continuously adjustable by the user, but rather produced fixed, due to construction, on the manufacturer's side, and thereby fixedly predefined. The selection of the width of the grinding gap can take place e.g. by using different rotors having different rotor diameters, or by counter-elements of different widths, instead of by manually setting the width of the grinding gap by radially adjusting the counter-element(s) by the user.

This ensures a very simple use of the laboratory mill, since no manual setting of the grinding gap by radial adjustment of the counter-element(s) is required, and can be omitted. If the counter-element(s) are worn, these are easily replaced by new ones (known as single-use principle). In order to select the desired width of the grinding gap, the user has available one, two or more further rotors having different diameters, which can be easily simply exchanged for discretely changing the width of the grinding gap. It is clear that some discrete values for the width of the grinding gap can be selected in this way.

Incorrect operation by the user, in particular incorrect adjustment of the grinding gap, is accordingly structurally excluded, and therefore the laboratory mill can also be operated by less experienced users.

The present disclosure also relates to a laboratory mill set including the laboratory mill and at least two, preferably at least three of more, rotors having predefined different diameters, and/or at least two or preferably at least three sets of counter-elements of different widths, wherein the selection of the width of the grinding gap between the rotor currently inserted in the grinding gap and the at least one counter-element is achieved not by the radial adjustment of the at least one counter-element but rather by exchanging the rotor or the counter-element for a different rotor having a different diameter, or different counter-elements having a different width.

If rotors having a rotor main body and separate cutting blades or separate beater bars are used, and the cutting blades or beater bars are firmly screwed to the rotor main body, an exact radial positioning of the cutting blades or beater bars should preferably also be ensured at the rotor, in order to define the grinding gap as exactly as possible at the manufacturer's site, in particular since the counter-element(s) are not adjustable radially, but rather are guided in a single discrete radially predefined position by the linear guide. For this purpose, the rotor main body comprising the cutting blade or the beater bars can comprise a tongue-and-groove connection for radial locking, and/or the cutting blades or beater bars can be firmly screwed to the rotor main body by fitting bolts.

However, the plugging of the stationary counter-element(s) into a linear guide with a radial form-fitting connection also has a further benefit. Specifically, this makes it possible for the counter-element(s) and thus also the grinder and the entire laboratory mill to be configured very compactly, since adjusting elements, such as setscrews and screws on the counter-elements, can be omitted, such that a synergy effect of simplicity, cost-efficiency and compactness can be achieved.

Preferably, the grinder housing comprises at least one or more receiving and guide slots for the counter-element(s), which slots extend axially along the rotor and radially. The end-face opening of the receiving and guide slot makes it possible for the associated counter-element to be plugged or inserted by hand axially into the respectively associated receiving slot, through the open end face. The counter-element(s) protrude radially inwards at least with an axial edge (counter-blade edge or counter-beater edge), from the respective receiving and guide slot into the grinding chamber, in order to comminute the grist between the rotor and the at least one axial edge, in a peripheral shell region of the grinding chamber. The axial linear guide between the receiving and guide slot(s) and the associated counter-element(s) preferably form an inner radial support for the respectively associated counter-element, such that the movement thereof radially inwards in the direction towards the rotor is limited, and ensure a precisely defined grinding gap.

The receiving and guide slot(s) can in each case comprises at least one guide groove, extending axially and transversely to the receiving and guide slot, as a guide rail, and the counter-element(s) can in each case comprise at least one tongue element that is displaceable in the at least one guide groove. However, the tongue and groove of the axially displaceable tongue-and-groove guide formed in this way could also be configured vice versa, i.e. the groove(s) in the counter-elements and the tongue(s) in the receiving and guide slots. Accordingly, the tongue-and-groove guide forms guide rails of the linear guide.

Preferably symmetrical axial guide grooves preferably extend on both sides of the receiving and guide slot(s). The receiving and guide slot(s) can thus, together with the guide grooves on both sides, have a substantially cross-shaped cross-section. In this case, the linear guides or the receiving and guide slot(s) and/or the guide grooves extend in each case axially and linearly from a rear, drive-side end to a front, door-side end. The linear guide(s) for the counter element(s) or the guide grooves are preferably provided transversely on both sides of the receiving and guide slots.

Such linear guides, receiving and guide slots, and guide groove, can be made with reasonable outlay in a solid metal grinder housing.

The counter-element(s) preferably each comprise two flat sides, which extend axially and radially in the respectively associated receiving and guide slot and rest against this when the counter-element(s) is plugged into the respectively associated receiving and guide slot. The terms “radial(ly)” or “extension in the radial direction” are not to be understood here strictly mathematically, but rather mean a direction which extends “substantially” radially, i.e. towards the inside or towards the outside, from the rotor axis. The “radial” direction in this sense therefore does not necessarily have to intersect the rotor axis in a mathematically exact manner. According to one embodiment, at least one, preferably at least two or more, transverse holes through the two flat side of the counter-element(s) are provided, in each of which holes a transverse pin is fastened, e.g. with a press-fit. The transverse pin(s) form the tongue element(s) which are radially guided and axially displaceable in the respectively associated guide groove, in order to form the respective linear sliding guide. Tongue-and-groove guides are preferably provided on both sides of the counter-element(s).

The radial limitation of the movement for forming a fixedly defined width of the grinding gap can be configured in the following manner. For limiting the movement radially inwards, the counter-element(s) can be supported on a radially inner side wall of the respectively associated guide groove of the tongue-and-groove guide, radially inwards in the direction of the rotor, such that the movement of the counter-element(s) radially inwards in the direction of the rotor is limited.

For limiting the movement radially outwards, the counter-element(s) can be supported on a radially outer side wall of the respectively associated guide groove of the tongue-and-groove guide, radially outwards in the direction away from the rotor, such that the movement of the counter-element(s) radially outwards in the direction away from the rotor is limited or a long side of the counter-element(s) facing away from the rotor can be supported directly or indirectly on a radially outer base of the respectively associated receiving and guide slot, such that the movement of the counter-element(s) is also limited radially outwards in the direction away from the rotor. As a result, a clearance fit of the linear guide with little play in the radial direction, e.g. of virtually zero to at most +/− a tenth millimeter, preferably +/− a few hundredths millimeters, can be formed, in order to define the width of the grinding gap in a structurally fixed manner.

In particular, the receiving and guide slot(s) can in each case comprise an axial bore on a radially outer base, into which bore an axially extending support pin is inserted. A long side of the counter-element(s) facing away from the rotor is then supported on the support pin, and the support pin is supported in the axial bore on the grinder housing, in order to limit the movement of the at least one counter-element radially outwards in the direction away from the rotor. This has the benefit that the loads acting radially towards the outside during grinding can be dissipated over a long line along the longitudinal pin, wherein the axial support pin can be configured e.g. as a hardened steel pin, for which in turn a large surface area within the axial bore is then available for load transfer to the grinder housing. This is beneficial in particular in the case of small laboratory mills.

The two end faces or end-face narrow sides of the counter-element(s) extend in particular in a plane transversely to the rotor axis, when the counter-element is inserted into the associated receiving and guide slot. In the vicinity of at least one of the two end faces, a draw opening can be provided in the counter-element, e.g. a transverse hole through the flat sides, such that a drawing tool, e.g. a draw hook, can be brought into form-fitting connection in the draw opening, in particular can be hooked in, in order to draw the counter-element axially out of the grinder housing or axially out of the associated receiving and guide slot by means of the draw tool, when the grinder housing door is open. In this way, the user can easily remove the counter-element(s) from the grinder housing e.g. in order to clean, turn or exchange them.

It is particularly simple to position the draw opening in the radial direction on the guide groove, such that the draw opening can be reached by the draw tool via the guide groove, which is present in any case.

Preferably the counter-element(s) each comprise a main body in the form of elongate flat plates or strips. The main bodies are in particular substantially cuboid. The counter-element(s) thus comprise two axially and radially extending flat sides, two long sides extending axially and transversely to the flat sides, and two end faces extending transversely to the flat sides and long sides, i.e. in a plane transversely to the rotor axis and in particular substantially in parallel with the axial end face of the grinder housing. The aspect ratio between the width and thickness of the main body is preferably at least 2 or at least 3.

At least one long edge between a flat side and an adjoining long side forms a blade or beater edge of the respective counter-element, which interacts with the blades or beater edges of the rotor in order to comminute the grist therebetween, wherein said long edge extends axially in the interior of the grinding chamber when the at least one counter-element is inserted into the at least one receiving and guiding slot of the grinder housing.

Although preferably the counter-element(s) are in principle configured as single-use parts, i.e. they are not resharpened, since otherwise the width of the grinding gap would no longer be correct, the counter-element(s) can, however, be configured such that they can be turned and thus used multiple times. For this purpose, the receiving and glide slots can be formed so as to be mirror-symmetrical. Furthermore, the counter-element(s) are in each case configured to be rotationally-symmetrical or such that they can be turned about 180° with respect to at least one, two or three of the following axes:
about an axis extending transversely to the flat side,
about an axis extending transversely to the long side, and/or
about an axis extending transversely to the end face, such that the counter-element(s) can be inserted into the associated receiving and guide slot no longer in just one, but rather in at least two, three or four, orientations.

The counter-element(s) can thus preferably be inserted into the grinder housing in a first orientation and a second orientation that is turned with respect to the first orientation, and/or in a third orientation that is turned with respect to the first and second orientation, and/or in a fourth orientation that is turned with respect to the first, second and third orientation, in order to use the first and second and/or third and/or fourth long edge of the at least one counter-element as a blade or beater edge. In other words, the counter-element(s) can be turned at least once, twice or three times, and, due to the turning, can be used at least twice, three times or four times.

Preferably for turning, at least four, in particular axially colinear, transverse holes can be present through the flat sides of the at least one counter-element, wherein in each case a continuous transverse pin that protrudes on both sides as a tongue element is fastened in the two axially inner transverse holes, e.g. with a press fit, and wherein the two axially outer holes remain free as draw openings.

The counter-elements plugged with the linear guide can be configured relatively small, in particular because the counter-elements are not screwed and more complex components such as setscrews and screws for adjusting and tightening can be omitted. They can, however, also be configured to be larger. Preferably, the main body of the axially insertable counter-elements can have a length of between 20 mm and 200 mm, preferably between 30 mm and 60 mm, a width of between 8 mm and 60 mm, preferably between 15 mm and 30 mm, and/or a thickness of between 3 mm and 25 mm, preferably between 4 mm and 8 mm.

An elastomer pressure element, e.g. in the form of an elastomer seal, can be fastened on the inside of the grinder housing, by means of which element the counter-element(s) can be axially clamped against the axial motor-side end of the receiving and guide slot, when the grinder housing is closed. This can prevent a residual movement on account of play in the linear guide.

The elastomer pressure element can be configured e.g. as an annular seal (O-ring) and e.g. fastened in an annular groove on the inside of the grinder housing door. The elastomer seal can fulfil a dual function, specifically on the one hand to annularly seal the guide grooves and/or the grinding chamber at the end face, and on the other hand to firmly clamp the counter-element(s).

Preferably, the grinding chamber can be configured as a substantially cylindrical, in particular substantially circular-cylindrical, cavity in the grinder housing, and can transition radially downwards into a grist outlet channel, through which the comminuted grist can trickle into a grist collecting container. The grinding chamber and the grist outlet channel can be separated by a curved sieve plate, in particular without a stable sieve cassette, through which plate the comminuted grist can trickle out of the grinding chamber, downwards into the grist outlet channel. The curved sieve plate and the rotor can be axially removed from the grinder housing when the grinder housing door is open. For this purpose, the curved sieve plate can be inserted or plugged into the grinder housing and can rest there between the grinding chamber and the grist outlet channel. The grinder housing is in particular rib-free on its front door-side end face in the region below the sieve plate, i.e. does not have any rib that transversely spans the grist outlet channel. As a result, the grinding chamber and the grist outlet channel can be brushed out together, without obstacles, from the end face of the grinder housing, in order to clean this, when the grinder housing door is open and the rotor and the curved sieve plate are removed. The grinding chamber and the grist outlet channel thus have a common unified front end-face opening.

According to an aspect of the present present disclosure, the laboratory mill, which is in particular configured as a cutting mill or cross beater mill, can comprise the following:
a device housing comprising a grinder housing, wherein the grinder housing defines a substantially cylindrical grinding chamber and has a front axial end face that is opposite the grinder drive,
a rotor-grinder in the grinding chamber of the grinder housing, wherein the rotor-grinder comprises a rotor, which defines a rotor axis, and at least one stationary counter-element, preferably a plurality of, in particular two, three, four or more stationary counter-elements, wherein the grist is comminuted between the rotor and the stationary counter-element(s), preferably arranged around the rotor along a peripheral line, when the rotor rotates,
a grinder drive in the device housing for driving the rotor in the grinding chamber,
a grinder housing door for closing the grinder housing at the axial end face, wherein the grinder housing door has an open and a closed state, wherein the user has axial access to the grinder in the open state of the grinder housing door,
wherein the grinding chamber is configured in the form of a substantially cylindrical cavity in the grinder housing and transitions downwards into a grist outlet channel, through which the comminuted grist can trickle or pour into a grist collecting container, wherein the grinding chamber and the grist outlet channel are separated by a curved sieve plate, in particular without a sieve cassette, through which the comminuted grist can pour trickle or out of the grinding chamber, downwards into the grist outlet channel, and
wherein at least one or more, preferably at least two or at least three, axial taper pins protrude out of the grinder housing door, which pins are pivoted under the curved sieve plate, by a pivot movement, upon closure of the grinder housing door, and support said plate at the bottom when the grinder housing door is closed.

It is thus possible for a simple flat, e.g. punched out of a perforated metal plate and subsequently curved, sieve plate or sieve cassette, to be guided in two lateral or sidelong grooves in the grinder housing without any other transverse reinforcement, and to be supported at the bottom, by the taper pins, on the end-face edge facing the grinder housing cover. The taper pins as a bottom support on the grinder housing door makes it possible to ensure that this can be swung shut without jamming.

The present disclosure will be explained in greater detail in the following on the basis of embodiments and with reference to the figures, wherein identical and similar elements are sometimes provided with the same reference signs, and the features of the different embodiments can be combined with one another.

### BRIEF DESCRIPTION OF THE FIGURES

In the figures:

FIG. 1 is a three-dimensional view of a cutting mill according to an embodiment of the present disclosure,

FIG. 2 is a view as in FIG. 1 with a transparent grinder housing,

FIG. 3 is a view as in FIG. 1 with an open grinder housing door,

FIG. 4 is a front view of the cutting mill from FIG. 1 without a grinder housing door,

FIG. 5 is an enlarged view of the detail A from FIG. 4,

FIG. 6 is a three-dimensional view of a cutting mill according to a further embodiment of the present disclosure without a grinder housing door,

FIG. 7 is a front view of the cutting mill from FIG. 6,

FIG. 8 is an enlarged view of the detail A from FIG. 7,

FIG. 9 is a longitudinal section through the cutting mill from FIG. 1,

FIG. 10 is a three-dimensional view of the stationary counter-element,

FIG. 11 is a plan view of a flat side of the counter-element from FIG. 10,

FIG. 12 is a front view of a long side of the counter-element from FIG. 10,

FIG. 13 is a view of an end face of the counter-element from FIG. 10,

FIG. 14 is a three-dimensional view of a rotor according to an embodiment of the present disclosure,

FIG. 15 is a three-dimensional view of a rotor according to a further embodiment of the present disclosure,

FIG. 16 is a horizontal section through the grinder housing,

FIG. 17 is a vertical section through the grinder housing,

FIG. 18 is a three-dimensional view of a cutting mill without a grinder housing door according to a further embodiment of the present disclosure,

FIG. 19 is a front view of the cutting mill from FIG. 18,

FIG. 20 is an enlarged view of the detail A in FIG. 19,

FIG. 21 is a three-dimensional view obliquely from the bottom left-hand side of the main body of the cutting mill from FIG. 6,

FIG. 22 is a three-dimensional view obliquely from the top right-hand side of the main body of the cutting mill from FIG. 6,

FIG. 23 is an exploded view of parts of a conventional cutting mill.

### DETAILED DESCRIPTION

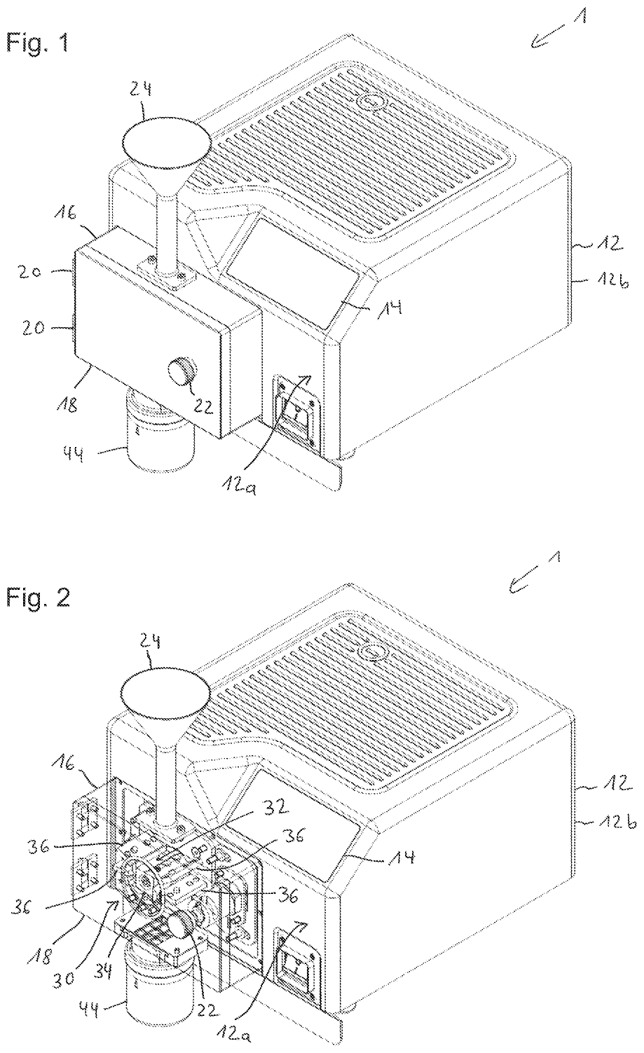

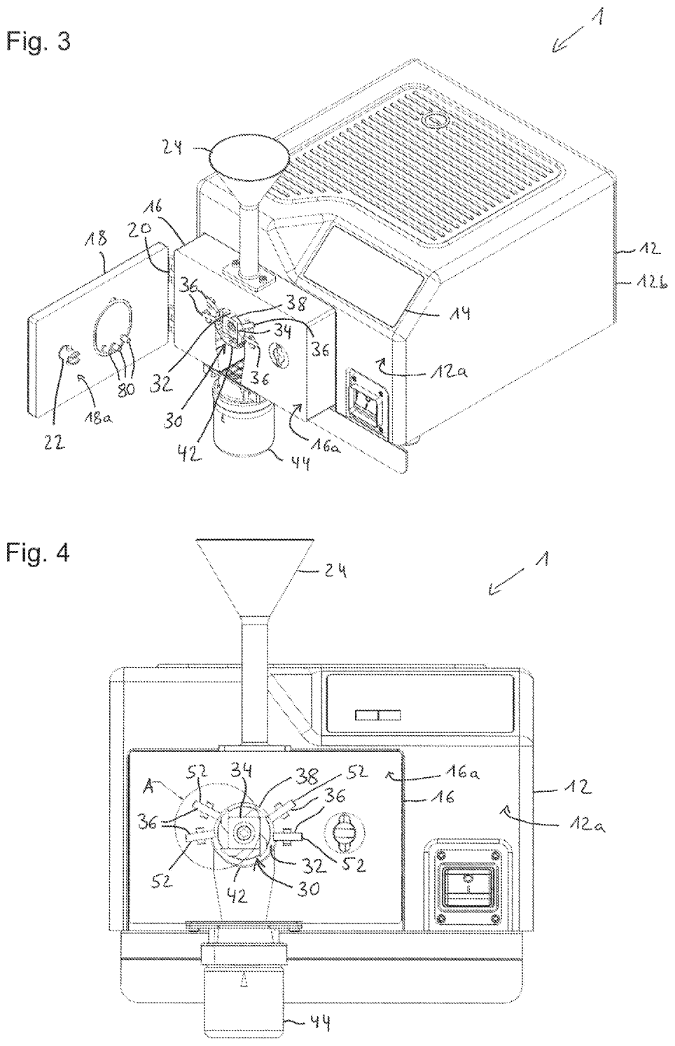

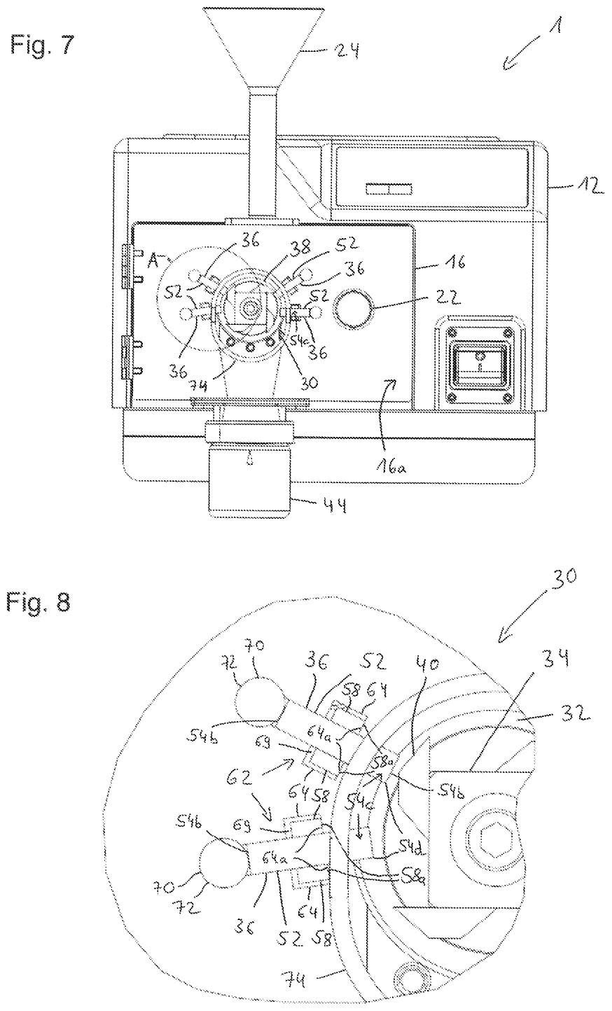

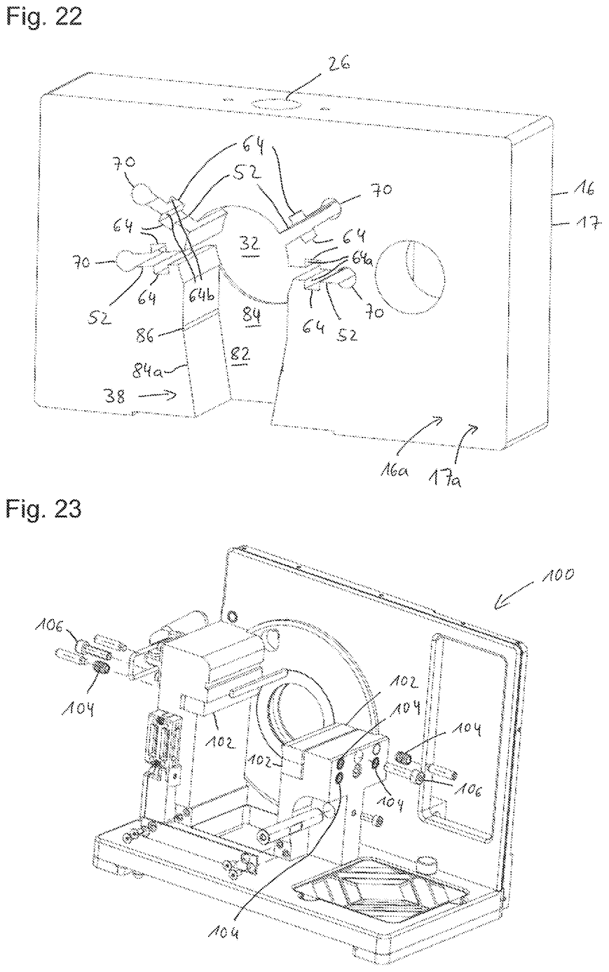

With reference to FIG. 1-9, a laboratory mill 1, in the present example in the form of a cutting mill, is shown. The laboratory mill 1 comprises a device housing 12 having a user display 14 for inputting grinding parameters into a control device (not shown) of the laboratory mill 1 by the user. A grinder housing 16 is arranged on the front side 12a of the device housing 12, which grinder housing can be closed (axially) at the front by a grinder housing door 18. The grinder housing door 18 is configured as a swing door and can be pivoted open and closed about hinges 20. The grinder housing door 18 can be locked with a door closure 22 when the grinder housing door 18, as shown in FIG. 1, is closed. When the grinder housing door 18 is closed, the grist can be filled in via a filling funnel 24 and an, in this example radial, filling opening 26 for grist (FIG. 21-22), such that during operation grist can be continuously fed to the cutting mill 1 and comminuted. When the closure element 22 is unlocked, the user can pivot the grinder housing door 18 open in order to achieve access to the rotor grinder 30 which is located in the interior or grinding chamber 32 of the grinder housing 16.

When the grinder housing door 18 is pivoted fully open, the user thus achieves axial access, via an axial user access opening 38, to the substantially circular-cylindrical grinding chamber 32 and the rotor-grinder 30 arranged therein which comprises a rotor 34 that rotates coaxially with the drive axis or rotor axis X and comprises a plurality of stationary counter-elements 36 which extend axially and are arranged annularly around the rotor 34. The example shows a cutting mill, such that the rotor 34 is configured as a cutting rotor and the stationary counter-elements 36 as stationary counter-blades. In the case of a correspondingly configured cross beater mill, the rotor 34 is configured as a beater rotor comprising beater bars, and the stationary counter-elements 36 are configured as counter-beater bars.

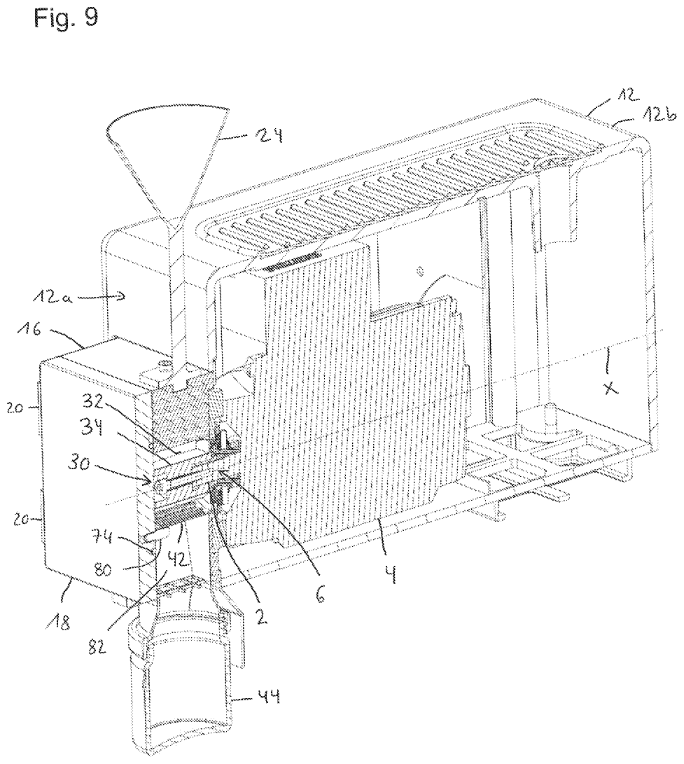

The rotor 34 is preferably plugged or pushed and axially screwed onto a drive shaft 2, which is driven at the back by a drive motor 4, and is driven by a form-fitting element. For this purpose, the drive shaft 2 extends through a central opening 6 between the rear part 12b of the device housing 12 and the grinder housing 16 that is flanged thereon at the front and also defines the coaxial rotor axis X (FIG. 9).

When the grinder housing door 18 is fully open, the user can release the rotor 34 and pull it axially from the drive shaft 2 and pull it out axially through the front axial user access opening 38 of the grinder housing 16. During operation, the rotor 34 rotates and the grist is supplied to the rotor-grinder 30 via the filling funnel 24 through the radial filling opening 26 for grist, and is comminuted between rotor blades 40 or beater bars of the rotor 34 and the stationary counter-elements 36, but a cutting action and/or beating action. Subsequently, the comminuted grist trickles e.g. through a sieve, downwards into a grist collecting container 44.

The stationary counter-elements 36 are fixed in the grinder housing 16, i.e. cannot be adjusted radially, that is to say are fixedly positioned radially. In the present example, they can be used four times, in that they are configured so as to be multiply rotationally symmetrical, such that they can be used in four different orientations and inserted inverted into the grinder housing 16. In order that the user can nonetheless select different widths of the grinding gap, depending on the grist, the laboratory mills 1 can for example be offered having different rotors 34 of different dimensions. For example, each laboratory mill 1 is offered having a set of three different rotors 34 which, in interaction with the radially non-adjustable counter-elements 36, for example provide three widths of the grinding gap of 0.2 mm, 0.6 mm and 1 mm. In this case, identical cutting blades 40 or beater bars can be used on the different rotors 34, which blades or bars can also be turnable twice. Only the simply producible rotor bodies 35 have different radial dimensions in each case. These radial dimensions of the rotor main body 35 ultimately determine the different discrete widths of the grinding gap, such that the selectable widths of the grinding gap do not originate from dimensions set in an undefined manner by the user, but rather are dimensionally clearly defined by production, from the rotor body 35, for example by machining. For this purpose, the rotor blades 40 or beater bars are clearly and precisely defined in their position on the rotor 34, for example via an axially extending tongue-and-groove connection 46 or via fitting screws 48. The rotor blades 40 or beater bars are machined in a geometrically exact manner, which can be achieved in a simple and cost-effective manner, since these must be sharpened in any case, and thus can be machined with a high degree of accuracy in a last work step.

Thus, the laboratory mill 1 does not allow for any continuous radial adjustment of the counter-elements 36 and thus the width of the grinding gap, but it provides a discrete number of for example two, three or more discrete values for the width of the grinding gap, which can be selected e.g. by means of rotors 34 of different diameters, i.e. from the supplier's catalogue. Alternatively, the discrete values for the width of the grinding gap can also be provided by means of different sets of counter-elements 36 having different widths.

The rotor 34 is plugged axially onto the drive shaft 2 via the user access opening 38. The laboratory mills 1 according to the present embodiments comprise, by way of example, four stationary counter-elements 36, which are inserted into four long axial receiving and guide slots 52 in the grinder housing 16, from a front axial end face 16a. In this case, the receiving and guide slots 52 form a single-axis, axially extending linear guide for the stationary counter-elements 36.

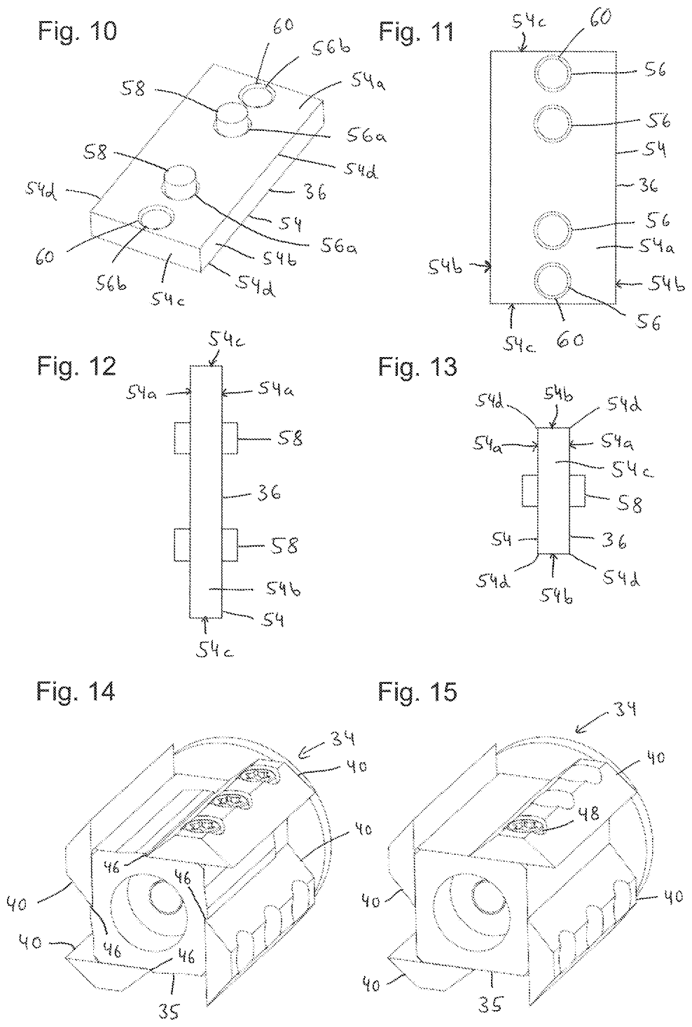

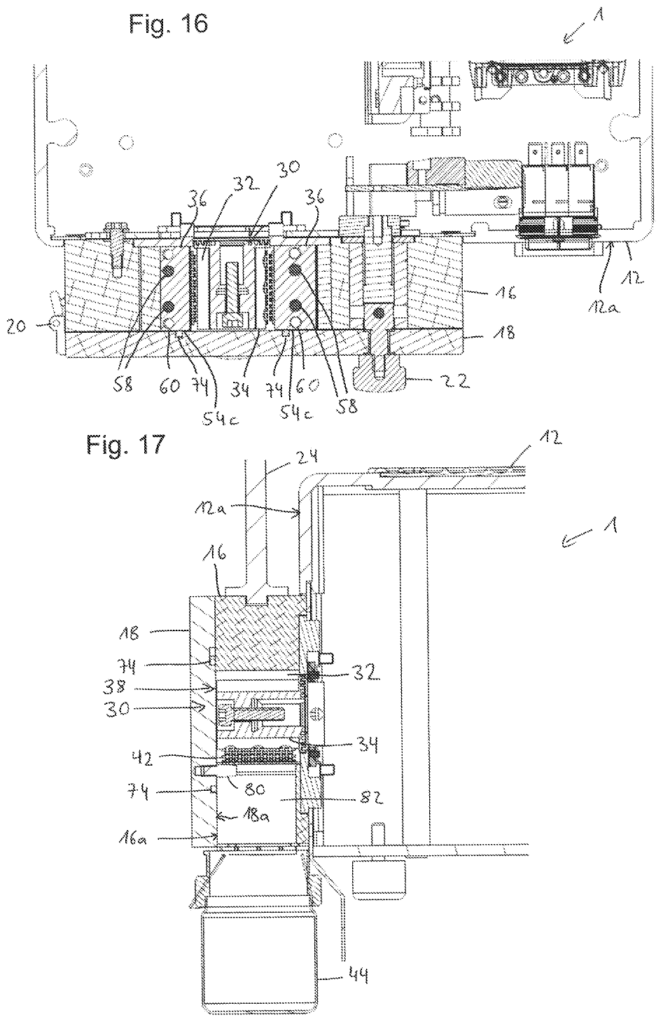

With reference to FIG. 10-13, the counter-elements 36 consist of a cuboid main body 54 having two flat sides 54a, two long sides 54b and two end faces 54c, and are integral, e.g. produced from hardened steel, tungsten carbide, or a ceramic material. In this example, four transverse holes 56 extend through the flat sides 54a, which holes can, for the sake of simplicity, be configured identically. In each case a guide or tongue pin 58 is pressed into the two axially inner transverse holes 56a, by means of a press fit. Thus, the axial linear guide 62 for the counter-elements 36 in the grinder housing 16 is configured in the form of a tongue-and-groove linear guide, in this example comprising two sliding bearings. The two axially outer holes 56b remain open and serve as draw openings 60, in order to be able to draw the counter-elements 36 out of the receiving and guide slots 52 again, for example by means of a draw tool (not shown) which is hooked into the front draw opening 60 in each case.

The counter-elements 36 shown here are configured extremely simply and do not comprise any adjusting elements, such as threaded holes for fastening screws, since they are positioned in a radially precise manner, by means of the linear guide, on a specified dimension due to manufacture (dimension cannot be changed by the user) in the grinder housing 16. The counter-elements 36 can be produced simply and can be relatively small, such that relatively compact laboratory mills 1 can be constructed thereby. In this embodiment, the length of the counter-elements 36 is just 40 mm, the width is 20 mm, and the thickness is 5 mm. The diameter of the tongue pins 58 is 5 mm, their excess on both sides, i.e. the engagement depth of the tongue-and-groove linear guide, is 2.5 mm.

The cuboid main body 54 of the counter-elements 36 consists integrally of a blade material, e.g. hardened steel, and the counter-elements 36 are configured to be rotationally symmetrical about 180°, about all three surface normals. All four long edges 54d between the flat sides 54a and the long sides 54b are configured as identical blades. Thus, the counter-elements 36 can be turned three times and axially inserted into the receiving and guide slots 52 in four different orientations, i.e. used four times.

The axial receiving and guide slots 52 are in each case open towards the grinding chamber 32 and comprise transversally on both sides, axially extending guide grooves 64, which together with the tongue elements or tongue pins 58 of the counter-elements 36, form a linear guide 62 in the form of a tongue-and-groove linear guide.

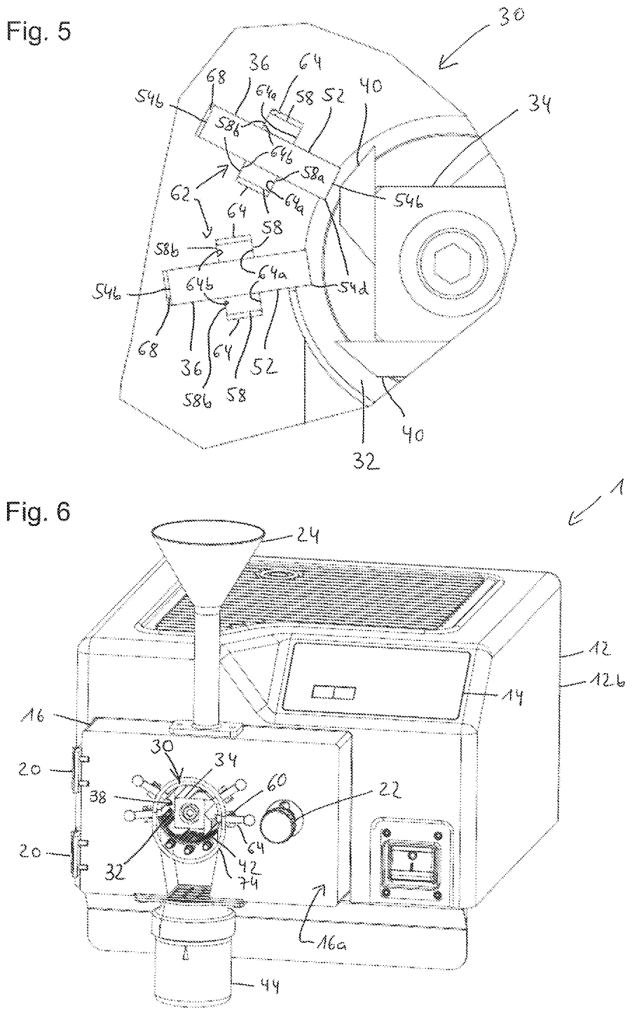

In the illustrative embodiment shown in FIG. 4-5, the fit between the tongue pins 58 and the guide grooves 64 is produced as a clearance fit, for example having play of +/− 5/100 mm, such that the tongue elements 58 form the radial support of the counter-elements 36 both radially inwards and radially outwards. The tongue elements 58 engage behind a radially inner running surface 64a of the associated guide groove 64 and are supported thereon radially towards the inside. The radially inner surface line 58a of the tongue element 58 thus forms, together with the running surface 64a, an inwardly acting stop, and the radially outwardly facing surface line 58b of the tongue element 58 forms, together with the radially outer running surface 64b, an outwardly acting stop of the linear guide 62 for the counter-element 36. Therefore, a radially outer clearance in the receiving and guide slot 52 is kept free. As a result, additional undercuts during milling can be saved. In addition, the outwardly acting load is dissipated over the relatively short surface lines 58b of the tongue pins 58. The linear guide 62 accordingly has two axially spaced radial load transfer points in the present example. If at least two axially spaced radial load transfer points are used, tilting moments can be prevented and a high gap parallelism can be ensured.

With reference to the illustrative embodiment shown in FIG. 6-8, the axially extending guide groove 64 can also be produced having a significant radial excess for a radially outer clearance 69. In this case, only the radially inwardly acting stop is formed between the tongue elements 68 and the guide groove 64. The radially outwardly acting stop is formed here by the radially outer long side 54b. In this example, the radially outer counter-stop is formed by a support pin 72, e.g. a hardened steel pin 72, extending in an axial bore 70. Although this variant requires an additional bore 70 and an additional support pin 72, the radially outwardly acting load is dissipated over a greater length, preferably over the entire length, of the radially outer long side 54b of the counter-element 36 or of the support pin 72. Nonetheless, additional undercuts can be omitted in the milling of the receiving and guide slots 52. As a result, the groove geometries can be kept simple. The support pins 72 can be pressed into the associated axial bore 70 by means of a press fit, since these do not have to be removed by the user.

In the two illustrative embodiments, the stationary counter-elements 36 are thus fixed against a movement towards the inside in the radial direction, i.e. towards the rotor 34, by means of the tongue-and-groove linear guide, or more precisely by means of the tongue elements 58 guided in the guide grooves 64. Thus, for the inserted counter-element 36 the axial linear guide 62 has at least no degrees of freedom of movement in the radial direction towards the rotor 34.

In the illustrative embodiment shown in FIGS. 4-5, the tongue elements 58 and the guide groove 64 also act away from the rotor, as a limiting stop. In the illustrative embodiment shown in FIGS. 6-8, the stop acting against a movement directed radially outwards or away from the rotor 34 is formed by the support pins 72. The axial linear guide 62 thus preferably also does not have any degrees of freedom of movement in the radial direction away from the rotor 34, for the inserted counter-element 36.

In both cases, the loosely inserted counter-elements 36 are thus preferably positioned in a radially fixed manner in the associated receiving and guide slots 52, in both directions radially towards the inside and radially towards the outside, apart from the radial play predetermined by the manufacturing tolerances, such that the width of the grinding gap is firmly predefined and no longer needs to be set and/or can also no longer be set.

A further benefit of the omission of the radial adjustment of the counter-elements 36 results from the fact that this requires, in the conventional cutting mills, for the rotor to be rotated for adjustment in such a way that the rotor blade 40 and the counter elements 36 are exactly opposite one another, in order to adjust the cutting gap. This can be omitted in the present present disclosure. Therefore, when the grinder housing door 18 is open the rotational drive of the rotor 34 can even be locked in a form-fitting manner, as a safety function. The present present disclosure can therefore be particularly helpful in combination with a form-fitting locking of the grinder drive, as is described in the patent application filed under the title “Laboratory mill” on the same day by the same applicant, even if this is not necessary. The laboratory mill 1 can e.g. have a form-fitting coupling, which is actuated by the door closure 22 by means of a mechanical manipulation chain, and locks the grinder in a form-fitting manner when the grinder housing door 18 is open. Regarding further details, reference is made to said parallel patent application.

The counter-elements 36 can be easily turned and/or exchanged by insertion and removal again into and out of the receiving and guide slots 52, or into and out of the linear guide 62, in particular since no setscrews or screws for adjustment and/or tightening are required. Furthermore, all the parts of the rotor-grinder 30, in particular the rotor 34 and the counter-elements 36, as well as the curved sieve 42, can be easily removed axially from the grinding chamber 32, when the grinder housing door 18 is open, such that the grinding chamber 32 can be easily cleaned of grinding dust, e.g. brushed out. Even if the grinding dust should attach to the counter-elements 36, these can be pulled out with sufficient extraction force by means of the draw openings 60. The laboratory mill 1 is therefore dirt-tolerant in this respect.

The grinder housing door 18 can additionally comprise an elastomer seal 74, for example an annular seal in a peripheral groove 76, on the inside 18a thereof facing the grinding chamber 32. The annular seal 74, e.g. an O-ring, seals the user access opening 38 or the grinding chamber 32 in an annular manner, when the grinder housing door 18 is closed, in order that no grinding dust can enter. The annular seal 74 extends peripherally and radially between the grinding chamber 32 and the guide grooves 64 of the receiving and guide slots 52. As a result, the guide grooves 64 can be largely kept free of grinding dust. For this purpose, the front end faces 54c of the counter-elements 36 close substantially flush with the front axial end face 16a of the grinder housing 16 or with a slight excess. The elastomer seal 74 firmly clamps the counter-elements 36 in the receiving and guide slots 52 against a rear end of the receiving and guide slots 52, such that the counter elements 36 are firmly fixed and do not rattle, when the grinder housing 16 is closed, even in the case of a slight clearance of the linear guide 62.

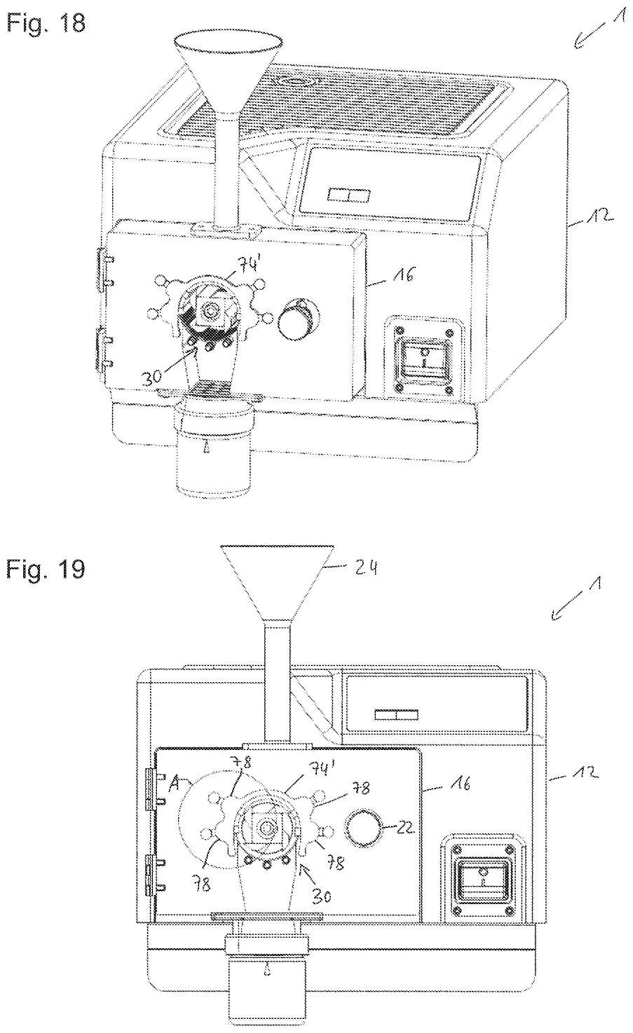

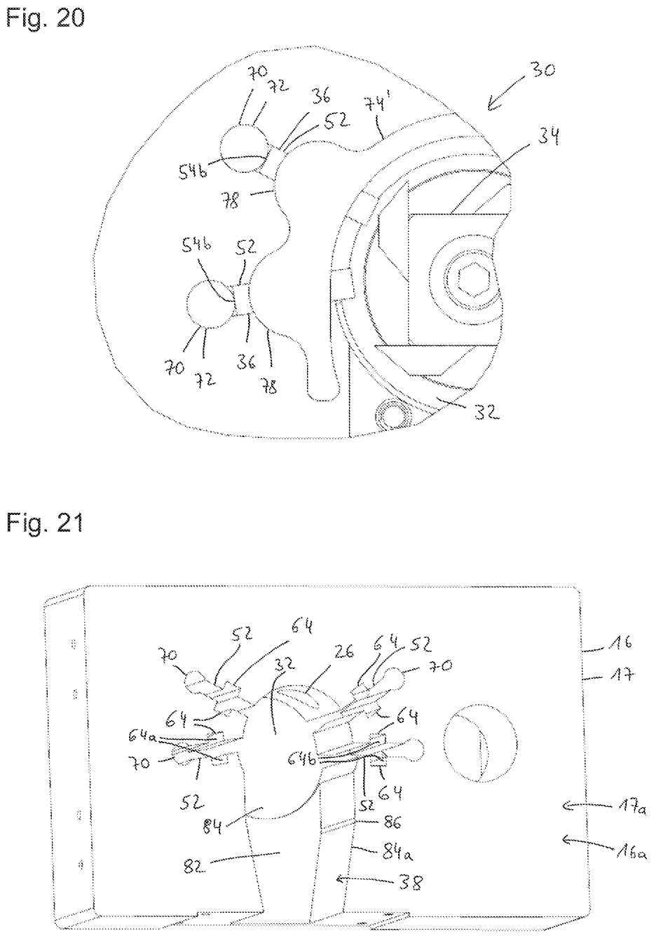

With reference to FIGS. 18-20, the elastomer seal 74 can also be configured as a special flat seal 74′ and comprise ears 78 which axially overlap and can fully close the front end faces of the guide grooves 64. The larger surface of the ears 78 also makes it possible for more force to be applied axially to the counter-elements 36.

Three taper pins 80 are fastened to the grinder housing door 18 slightly below the grinding chamber 32, which pins protrude from the inside 18a of the grinder housing door 18. When the grinder housing door 18 is closed, in particular by a pivoting movement about the hinges 20, the taper pins 80 pivot in a pivot trajectory under the curved sieve plate 42 and finally support said plate at the bottom. As a result, a support rib for the sieve plate 42 that is fixedly fastened to the grinder housing 16 and transversely bridges the user access opening 38 can be omitted. The use of taper pins 80 has been found to be particularly helpful with respect to the pivot trajectory in combination with the shaping of the curved sieve plate 42.

With reference to FIGS. 21-22, the grinder housing 16 can comprise an integral main body or housing block 17, and e.g. be milled in one piece from a metal block. In this case, the receiving and guide slots 52, the guide grooves 64, the grinding chamber 32, and/or a grist outlet channel 82 that adjoins the grinding chamber at the bottom, can be worked out of the metal block as a coherent, inter-communicating cavity 84.

The cavity 84 is preferably milled cylindrically with a complex surface line 84a. The front end face of the cylindrical cavity 84 is preferably completely open. In other words, the coherent cylindrical cavity 84 consisting of inter-communicating receiving and guide slots 52, guide grooves 64, grinding chamber 32 and/or the grist outlet channel 82 that adjoins the grinding chamber at the bottom, opens completely, with a uniform common opening surface, limited by the surface line 84a of the cylindrical cavity 84, at the front end face 17a of the housing block 17. As a result, the grinder housing can on the one hand be milled in a cost-effective manner, e.g. from an aluminum or stainless steel block, and on the other hand a compact, small laboratory mill 1 having a small grinder 30 can be constructed.

The sieve plate 42 can be produced relatively simply and flexibly from a simple perforated plate, since despite the wide uniform user access opening 38, which allows access without a transverse rib both to the substantially circular-cylindrical grinding chamber 32 and to the relatively wide grist outlet channel 82. The entire cavity 84 consisting of the grinding chamber 32 and the grist outlet channel 82, which is formed integrally therewith, is open without obstacles at the front end face 16a of the grinder housing 16, when the grinder housing door 18 is open. The taper pin 80 makes it possible for bending of the sieve plate 42 during operation to be prevented. The sieve plate 42 is inserted between the counter-elements 36 and a support surface 86 between the grinding chamber 32 and the grist outlet channel 82.

It is clear to a person skilled in the art that the embodiments described above are to be understood by way of example and the present disclosure is not limited to these, but rather can be varied in a variety of ways without departing from the scope of protection of the claims. Components described in the singular are also to be understood in the plural, and vice versa. Furthermore, it is clear that the features, irrespective of whether they are disclosed in the description, the claims, the figures or elsewhere, also define individual components of the present disclosure, even if they are described together with other features.

1. A laboratory mill for comminuting grist, and configured as a cutting mill or cross beater mill, comprising
a device housing having a grinder housing, wherein the grinder housing defines a grinding chamber and has an axial end face,
a rotor-grinder in the grinding chamber of the grinder housing, wherein the rotor-grinder comprises a rotor, which defines a rotor axis, and at least one counter-element, wherein the grist is comminuted between the rotor and the at least one counter-element when the rotor rotates,
a grinder drive for driving the rotor in the grinding chamber, and
a grinder housing door for closing the grinder housing at the axial end face,
wherein the at least one counter-element can be inserted axially into the grinder housing when the grinder housing door is open.

2. The laboratory mill according to claim 1,
wherein the at least one counter-element is guided in the grinder housing with a radially form-fitting connection.

3. The laboratory mill according to claim 2,
wherein the radially form-fitting connection forms a support against a movement of the at least one counter-element, at least radially inwards towards the rotor.

4. The laboratory mill according to claim 1,
wherein the grinder housing comprises at least one axially extending receiving and guide slot for the at least one counter-element, wherein the receiving and guide slot is open radially inwards towards the rotor and at an axial end face of the grinder housing, and the at least one counter-element can be inserted axially into the at least one receiving and guide slot through the open end face, and wherein an axial linear guide is formed between the at least one receiving and guide slot and the at least one counter-element.

5. The laboratory mill according to claim 4,
wherein the at least one receiving and guide slot comprises at least one guide groove which extends axially and transversely to the receiving and guide slot, and the at least one counter-element comprises at least one tongue element which is displaceable in the at least one guide groove, or vice versa, such that the axial linear guide is configured as an axially displaceable tongue-and-groove guide.

6. The laboratory mill according to claim 5,
wherein the at least one counter-element comprises two flat sides which extend axially in the at least one receiving and guide slot when the at least one counter-element is inserted into the at least one receiving and guide slot, wherein at least one transverse hole through the flat sides of the at least one counter-element is provided, in which hole a transverse pin is fastened, which, as the tongue element, is axially displaceable and radially guided in the at least one guide groove.

7. The laboratory mill according to claim 5,
wherein the at least one counter-element is supported radially inwardly, in a direction towards the rotor, on a side wall of the guide groove of the tongue-and-groove guide, and/or
wherein the at least one counter-element is supported radially outwards, in a direction away from the rotor, on a side wall of the guide groove of the tongue-and-groove guide, or wherein a long side of the at least one counter-element facing away from the rotor is supported directly or indirectly on a radially outer base of the receiving and guide slot.

8. The laboratory mill according to claim 4,
wherein the receiving and guide slot comprises an axial bore on a radially outer base, into which bore an axially extending support pin is inserted, and wherein a long side of the at least one counter-element, facing away from the rotor, is supported on the support pin, and wherein the support pin is supported in the axial bore, on the grinder housing.

9. The laboratory mill according to claim 1,
wherein the at least one counter-element comprises at least one draw opening, such that a draw tool can be brought into form-fitting connection in the draw opening, in order to draw the at least one counter-element axially out of the grinder housing with the aid of the draw tool, when the grinder housing door is open.

10. The laboratory mill according to claim 1,
wherein the at least one counter-element comprises a main body in the form of an elongate plate or strip.

11. The laboratory mill according to claim 10,
wherein the length of the main body is between 20 mm and 200 mm, the width of the main body is between 8 mm and 60 mm, and/or the thickness of the main body is between 3 mm and 25 mm.

12. The laboratory mill according to claim 1,
wherein the at least one counter-element comprises at least one flat side and at least one long side, which adjoin one another at a long edge, wherein the long edge forms a blade or beater edge of the at least one counter-element, which interacts with blades of beater edges of the rotor in order to comminute the grist therebetween.

13. The laboratory mill according to claim 12,
wherein the at least one long side extends axially in the grinding chamber, when the at least one counter-element is inserted into the at least one receiving and guide slot of the grinder housing.

14. The laboratory mill according to claim 1,
wherein the at least one counter-element comprises a main body in the form of an elongate plate or strip, which comprises two flat sides, two long sides extending axially and transversely to the flat sides, and/or two end faces extending transversely to the flat sides and to the long sides, and
wherein the at least one counter-element is configured such that it can be turned about 180°, in particular with respect to at least one, two or three of the following axes:
about an axis extending transversely to the flat side,
about an axis extending transversely to the long side, and/or
about an axis extending transversely to the end face,
such that the at least one counter-element can be inserted into the grinder housing in a first orientation and a second orientation that is turned with respect to the first orientation, and/or in a third orientation that is turned with respect to the first and second orientation, and/or in a fourth orientation that is turned with respect to the first, second and third orientation, in order to use a first and second and/or third and/or fourth long edge of the at least one counter-element as a blade or beater edge.

15. The laboratory mill according to claim 4,
wherein the at least one counter-element comprises two flat sides which extend axially in the at least one receiving and guide slot when the at least one counter-element is inserted into the at least one receiving and guide slot, wherein at least four transverse holes through the flat sides of the at least one counter-element are provided, wherein in each case a continuous transverse pin, which protrudes on both sides, is fastened in two axially inner transverse holes as a tongue element, and wherein two axially outer transverse holes form draw openings.

16. The laboratory mill according to claim 4,
wherein a resilient pressure element is fastened on the grinder housing door, which presses an axial end face of the at least one counter-element axially against an axial motor-side end of the receiving and guide slot, when the grinder housing door is closed.

17. The laboratory mill according to claim 4,
wherein an annular seal is included, which is fastened to the grinder housing door and seals against the axial end face of the grinder housing, and thereby seals the grinding chamber in an annular manner, and wherein the annular seal presses an axial end face of the at least one counter-element axially against an axial motor-side end of the receiving and guide slot, when the grinder housing door is closed.

18. The laboratory mill according claim 1,
wherein the grinding chamber is formed as a substantially cylindrical cavity in the grinder housing and transitions radially downwards into a grist outlet channel, wherein the grinding chamber and the grist outlet channel are separated by a sieve plate, through which comminuted grist can trickle out of the grinding chamber downwards into the grist outlet channel and into a grist collecting container, wherein the sieve plate and the rotor can be axially removed from the grinder housing when the grinder housing door is open, and wherein the grinder housing does not have any ribs transversely bridging the grist outlet channel, at its end face in a region under the sieve plate, such that the grinding chamber and the grist outlet channel can be brushed out together, without obstacles, from the end face of the grinder housing, when the grinder housing door is open and the rotor and the sieve plate are removed.

19. A laboratory mill for comminuting grist, and configured as a cutting mill or cross beater mill, comprising
a device housing having a grinder housing, wherein the grinder housing defines a grinding chamber and has an axial end face,
a rotor-grinder in the grinding chamber of the grinder housing, wherein the rotor-grinder comprises a rotor, which defines a rotor axis, and at least one counter-element, wherein the grist is comminuted between the rotor and the at least one counter-element when the rotor rotates,
a grinder drive for driving the rotor in the grinding chamber,
a grinder housing door for closing the grinder housing at the axial end face,
wherein the grinding chamber is configured in the form of a substantially cylindrical cavity in the grinder housing and transitions downwards into a grist outlet channel, wherein the grinding chamber and the grist outlet channel are separated by a sieve plate, through which comminuted grist can trickle out of the grinding chamber, downwards into the grist outlet channel and into a grist collecting container, and
wherein at least one or more protruding taper pins are fastened to the grinder housing door, which are pivoted in, under the sieve plate, when the grinder housing door is closed, and support said sieve plate at a bottom when the grinder housing door is closed.

20. A laboratory mill set composed of the laboratory mill according to claim 1, and at least two, rotors having predefined different diameters, wherein a selection of a width of a grinding gap between the rotor inserted into the grinding chamber and the at least one counter-element is achieved not by radial adjustment of the at least one counter-element but rather by exchanging the rotor for another rotor of a different diameter.

21. A laboratory mill set composed of the laboratory mill according to claim 1, and at least two sets of counter-elements of different widths, wherein a selection of a width of a grinding gap between the counter-elements inserted into the grinder housing and the rotor is achieved not by radial adjustment of the counter-elements but rather by exchanging the counter-elements for other counter-elements of a different width.
